(19) United States
(12) Patent Application Publication
(10) Pub. No.: US 2004/0159518 A1
(43) Pub. Date: Aug. 19, 2004

(54) Door handle input decoupler for a cinching latch actuator

(76) Inventor: G. Clarke Oberheide, Troy, MI (US)

Correspondence Address: David J. Simonelli, Esq., Clark Hill PLC, Suite 3500, 500 Woodward Ave., Detroit, MI, 48226-3435, US

(21) Appl. No.: 10/757,960

(22) Filed: Jan. 15, 2004

Related U.S. Application Data
(60) Provisional application No. 60/440,292, filed on Jan. 15, 2003.

(51) Int. Cl. F16D 11/14

(52) U.S. Cl. 192/69.9

(57) ABSTRACT

A mechanical clutch assembly is used to selectively disengage a motor from a cinching latch of a closure panel having a handle. The mechanical clutch assembly includes a housing defining a longitudinal axis, an axial opening and a peripheral opening. The mechanical clutch assembly also includes a shaft that extends through the housing and out the axial opening. The shaft extends along the longitudinal axis of the housing. A driven gear is rotatably secured to the shaft and axially positioned by the housing. The driven gear is operatively connected to the motor and is driven thereby. A pinion gear is secured to the shaft and selectively engages the driven gear. The mechanical clutch assembly also includes a clutch extending between the driven gear and the pinion gear allowing the pinion gear to disengage the driven gear allowing the motor to back drive when the liftgate handle is operated manually.

### FIELD OF THE INVENTION

The invention relates to cinching latch mechanisms for liftgates of motor vehicles. More specifically, the invention relates to a mechanical clutch assembly for a motorized cinching latch mechanism for a liftgate of a motor vehicle.

### DESCRIPTION OF THE RELATED ART

Cinching latches are used with closure panels, e.g., side doors, sliding doors, liftgates and, in some instances, deck lids, to secure the closure panel. The cinching latches are commonly used when the closure panel is powered from the open position to the closed position. In addition, cinching latches are used in manual operation to facilitate the closing of the closure panel without the operator thereof slamming the closure panel closed. More specifically, the operator merely moves the closure panel close to the closed position and the cinching latch completes the closure of the closure panel.

Cinching latches are also used to automatically secure and/or release the closure panel from the closed position. In this situation, the cinching latch releases the closure panel allowing the closure panel to move to a partially open position. From that position, manual power or power-assist devices, e.g., pneumatic struts or springs, or automatic opening mechanisms move the closure panel to its fully open position.

The cinching latch mechanisms require the ability of the operator to override the cinching latch mechanism to completely and manually close the closure panel. Also, the cinching latch mechanisms need to allow for operation of the closure panel during periods of loss of power. Typical cinching latch mechanisms incorporate electromagnetic clutches to facilitate the manual closing of the liftgate to its fully closed position. The electromagnetic clutch is not desired because it is costly and requires a great deal of power to operate.

### SUMMARY OF THE INVENTION

A mechanical clutch assembly is used to selectively disengage a motor from a cinching latch of a closure panel having a handle. The mechanical clutch assembly includes a housing defining a longitudinal axis, an axial opening and a peripheral opening. The mechanical clutch assembly also includes a shaft that extends through the housing and out the axial opening. The shaft extends along the longitudinal axis of the housing. A driven gear is rotatably secured to the shaft and axially positioned by the housing. The driven gear is operatively connected to the motor and is driven thereby. A pinion gear is secured to the shaft and selectively engages the driven gear. The mechanical clutch assembly also includes a clutch extending between the driven gear and the pinion gear allowing the pinion gear to disengage the driven gear allowing the motor to back drive when the liftgate handle is operated manually.

### BRIEF DESCRIPTION OF THE DRAWINGS

Advantages of the invention will be readily appreciated, as the same becomes better understood by reference to the following detailed description when considered in connection with the accompanying drawings, wherein:

FIG. 1 is a perspective view of one embodiment of the invention secured to a cinching latch of a motor vehicle, partially cut away;

FIG. 2 is a perspective view of a housing for a cinching latch actuator;

FIG. 3 is a perspective view of the invention with a pinion gear engaged with a driven gear;

FIG. 4 is a perspective view of the shaft and driven gear of the mechanical clutch assembly according to one embodiment of the invention; and

FIG. 5 is a cross-sectional side view of an alternative embodiment of the invention.

### DETAILED DESCRIPTION OF THE PREFERRED EMBODIMENT

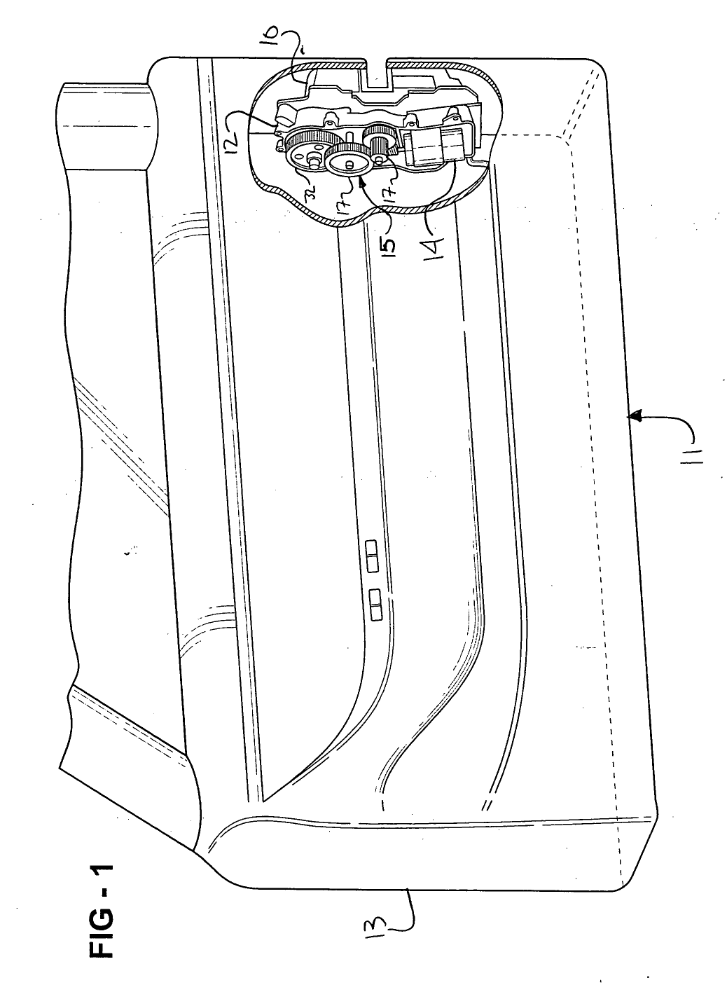

Referring to FIG. 1, a cinching latch 10 is fixedly secured to a motor vehicle generally shown at 11. The cinching latch 10 cinches a striker (not shown) secured to a door jamb or pillar (not shown) used to close and secure a closure panel 13. It should be appreciated by those skilled in the art that the cinching latch 10 can be used for any automotive closure panel, including, but not limited to, side pivoting doors 13, sliding side doors, liftgates, deck lids and the like.

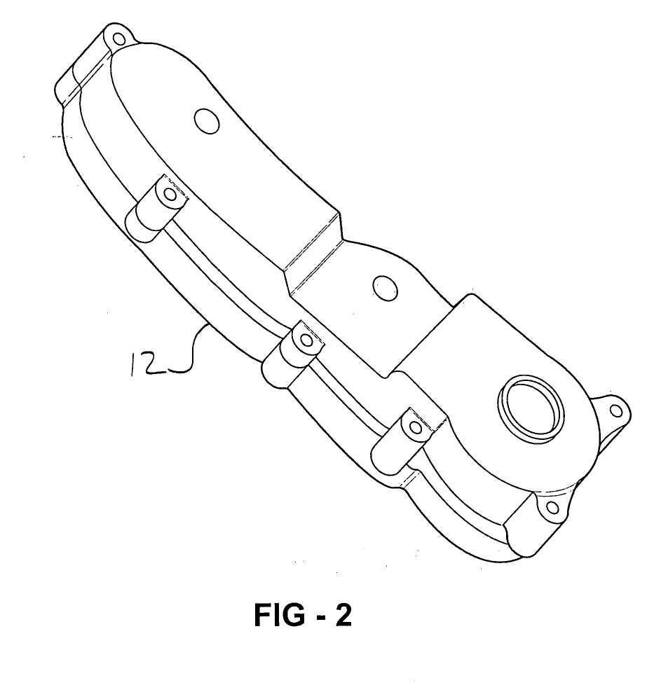

Secured to the cinching latch 10 is an actuator housing 12. The actuator housing 12 is fixedly secured to the latch 10 of the closure panel. The cinching latch 10 includes a motor 14 that actuates the cinching latch 10. The actuator housing 12 is shown in FIG. 2. In FIG. 1, the lid of the actuator housing 12 is removed to show the transmission 15. The transmission 15 includes a gear train 17 that eventually engages a driven gear 32, discussed in greater detail subsequently.

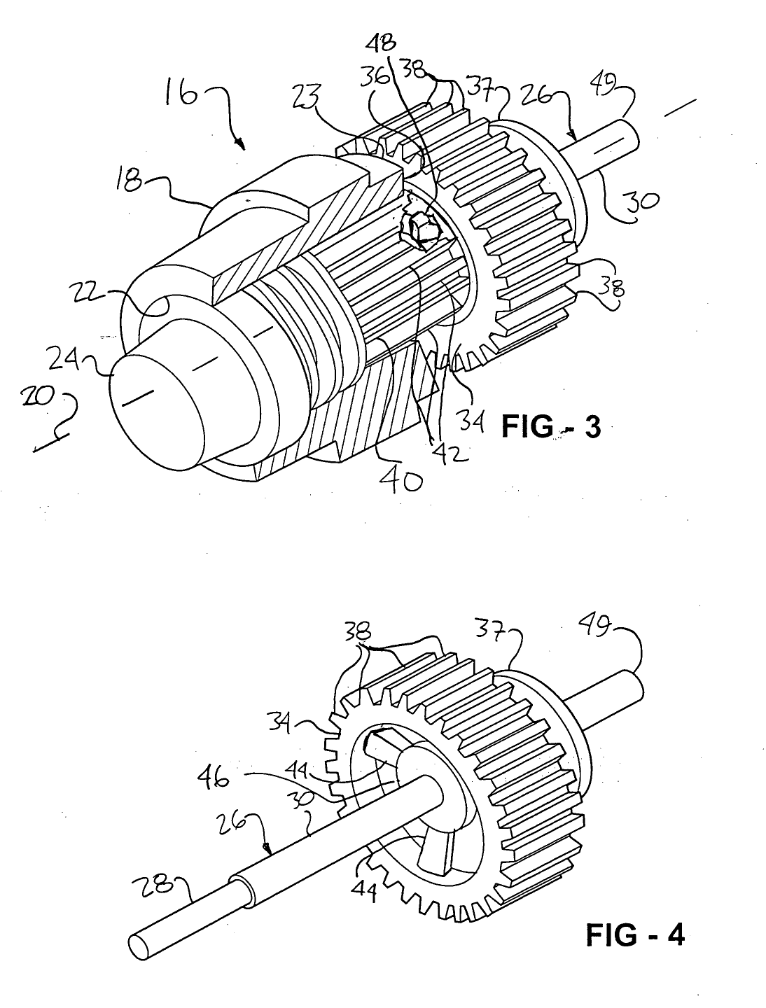

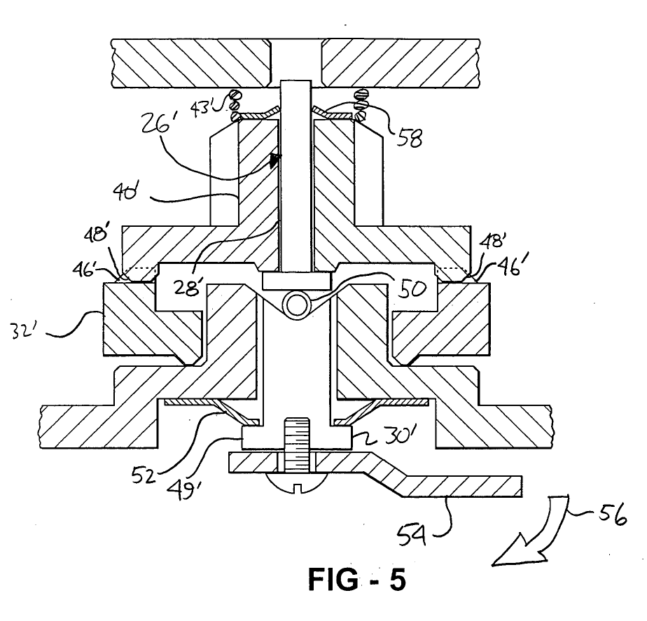

Disposed inside the actuator housing 12 is a mechanical clutch assembly, generally indicated at 16 in FIG. 3. The mechanical clutch assembly 16 includes a clutch housing 18. The clutch housing 18 defines a longitudinal axis 20 extending therethrough. The clutch housing 18 also defines an axial opening 22 and a peripheral opening 23 opposite a closed end 24. In FIG. 3, the axial opening 22 is cut away further to show more detail inside the housing 18.

A shaft, generally shown at 26, extends through the housing 18 and out the peripheral opening. The shaft 26 extends along the longitudinal axis 20. Referring to FIG. 4, the shaft 26 includes a first shaft member 28 telescoping within a second shaft member 30. A spring internal to the shaft 26 biases the first shaft member 28 out and away from the second shaft member 30. Therefore, the shaft 26 may be compressed by forcing the second shaft member 30 over the first shaft member 28.

The mechanical clutch assembly 16 also includes the driven gear 32 that is rotatable about the shaft 26 while being axially positioned by the housing 18. More specifically, the driven gear 32 is free to rotate the shaft 26, but does not move axially therealong because a side surface 34 of the driven gear 32 abuts a ledge 36 of the housing 18 preventing it from moving should the shaft 26 be compressed. In addition, a collar 37, fixedly secured to the shaft 26, prevents the driven gear 32 from moving axially away from the actuator housing 12.

The driven gear 32 includes a plurality of teeth 38 extending around the periphery of the driven gear 32. The plurality of teeth 38 operatively engage the motor 14 via the transmission 15. The driven gear 32 receives the rotational force from the motor 14 and rotates about the shaft 26.

The mechanical clutch assembly 16 also includes a pinion gear 40 having a plurality of teeth 42 extending thereabout. The pinion gear 40 rotates with respect to the shaft 26. The pinion gear 40 does move, however, with the shaft 26 as it is compressed and allowed to expand. More specifically, the pinion gear 40 moves axially within the housing 18 upon compression of the shaft 26. The axial movement of the pinion gear 40 allows it to selectively engage in the driven gear 32. When the shaft 26 is compressed, the pinion gear 40 disengages the driven gear 32. A pinion spring 43 biases the pinion gear 40 into engagement with the driven gear 32.

The pinion gear 40 is operatively connected to the cinching latch 10. Therefore, when the pinion gear 40 is disengaged from the driven gear 32, the latch of the cinching latch 10 may be operated without effecting the rotational position of the motor 14. Therefore, the latch may be operated without having to overcome the forces generated by the motor 14 if it is not moving. This will allow the movement of the closure panel 13 without requiring to overcome the forces of the motor 14 when it is in its park position.

The mechanical clutch assembly 16 extends between the driven gear 32 and the pinion gear 40. The clutch assembly 16 allows the pinion gear 40 to disengage the driven gear 32 allowing the motor 14 to back drive when the handle is operated manually. As may be seen in FIG. 3, the clutch assembly 16 includes a first set of clutch teeth 44 that extend from a center portion 46 of the driven gear 32. The first set of clutch teeth 44 engages a similarly designed second set of clutch teeth 48 that extend radially out from a center portion of the pinion gear 40 to engage the pinion 40 and driven 32 gears.

In operation, to disengage the motor 14 from the cinching latch actuator 10, a button is pressed which moves a release end 49 of the shaft 26 axially inwardly toward the housing 18. The release end 49 may be operated by a push button or by the handle itself. When the release end 49 receives a force to move axially inwardly, the pinion gear 40 moves with the shaft 26 as it telescopingly collapses upon itself. Because the driven gear 32 cannot move axially due to the ledge 36 in the housing 18, the first set of clutch teeth 44 in the driven gear 32 is separated from the second set of clutch teeth of the pinion gear 40. This allows the driven gear 32 to be driven, regardless of its direction, allowing the handle to be operated manually without the force of the motor 14 being applied thereto.

Referring to FIG. 4, wherein like prime numerals represent similar elements of a different embodiment, the mechanical clutch assembly 16′ is shown in cross section. As may be seen, the clutch teeth 44′ of the driven gear 32′ engage clutch teeth 48′ of the pinion gear 40. In this embodiment, the shaft 26′ is not telescoping. The shaft 26′ includes a first shaft member 28′ and a second shaft member 30′ that abut each other through a resilient member 50. A positioning spring 52 forces the second shaft member 30′ away from the pinion gear 40′. In addition, the positioning spring 52 maintains the second shaft member 30′ coaxial with the rest of the clutch assembly 16′.

A lever 54 can be rotated in the direction of an arrow 56 to force the second shaft member 30′ into the first shaft member 28′. This will force the pinion gear 40′ away from the driven gear 32′ which, in turn, separates the clutch teeth 48 of the pinion gear 40′ from the clutch teeth 44′ of the driven gear 32′.

The second embodiment also includes a flexible collar 58 that maintains the pinion gear 40′ aligned with the first shaft member 28′. The flexible collar 58 is surrounded by a pinion spring 43′, which operates in the same fashion as the pinion spring 43 of the first embodiment.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed is:

1. A mechanical clutch assembly for selectively disengaging a motor from a cinching latch of a closure panel having a handle, said mechanical clutch assembly comprising:
a housing defining a longitudinal axis, an axial opening and a peripheral opening;
a shaft extending through said housing and out said axial opening along said longitudinal axis;
a driven gear rotatably secured to said shaft and axially positioned by said housing, said driven gear operatively connected to said motor and driven thereby;
a pinion gear secured to said shaft and selectively engagable with said driven gear; and
a clutch extending between said driven gear and said pinion gear allowing said pinion gear to disengage said driven gear allowing the motor to back drive when the handle and closure panel are operated manually.

2. A mechanical clutch assembly as set forth in claim 1 wherein said clutch includes a first set of clutch teeth fixedly secured to said driven gear.

3. A mechanical clutch assembly as set forth in claim 2 including a second set of clutch teeth fixedly secured to said pinion gear wherein said second set of clutch teeth is selectively engagable by said first set clutch teeth of said driven gear when said driven gear is engaged with said pinion gear allowing the motor to operating the cinching latch.

4. A mechanical clutch assembly as set forth in claim 3 wherein said shaft includes a first shaft member and a second shaft member coaxial with said first shaft member.

5. A mechanical clutch assembly as set forth in claim 4 wherein said first shaft member telescopes within said second shaft member.

6. A mechanical clutch assembly as set forth in claim 5 including a pinion spring extending between said housing and said pinion gear to bias said pinion gear toward said driven gear to allow said second set of clutch teeth to engage said first set of clutch teeth.

7. A mechanical clutch assembly as set forth in claim 6 wherein said second shaft member includes a release end for receiving a releasing force to overcome said pinion spring to disengage said pinion gear from said driven gear.

8. A mechanical clutch assembly as set forth in claim 7 including a collar fixedly secured to said second shaft such that said collar extends out from said second shaft perpendicularly therefrom.

9. A mechanical clutch assembly as set forth in claim 8 wherein said collar extends between said driven gear and the cinching latch.

10. A mechanical clutch assembly for selectively disengaging a motor from a cinching latch of a closure panel having a handle, said mechanical clutch assembly comprising:
a housing defining a longitudinal axis, an axial opening and a peripheral opening;
a shaft extending through said housing and out said axial opening along said longitudinal axis, said shaft including a first shaft member, a second shaft member and a resilient member extending therebetween;
a driven gear rotatably secured to said shaft and axially positioned by said housing, said driven gear operatively connected to said motor and driven thereby;
a pinion gear secured to said shaft and selectively engagable with said driven gear; and
a clutch extending between said driven gear and said pinion gear allowing said pinion gear to disengage said driven gear allowing the motor to back drive when the handle and closure panel are operated manually.

11. A mechanical clutch assembly as set forth in claim 10 wherein said clutch includes a first set of clutch teeth fixedly secured to said driven gear.

12. A mechanical clutch assembly as set forth in claim 11 including a second set of clutch teeth fixedly secured to said pinion gear wherein said second set of clutch teeth is selectively engagable by said first set clutch teeth of said driven gear when said driven gear is engaged with said pinion gear allowing the motor to operate the cinching latch.

13. A mechanical clutch assembly as set forth in claim 12 including a lever fixedly secured to said second shaft member to force said first and second shaft members axially with respect to said driven gear to disengage said pinion gear from said driven gear.

14. A mechanical clutch as set forth in claim 13 including a positioning spring extending between said housing and said first shaft member to align said first shaft member coaxially with said second shaft member in the absence of forces being applied to said lever.

15. A mechanical clutch assembly as set forth in claim 14 including a flexible collar securing said pinion gear along said first shaft member.

16. A mechanical clutch assembly as set forth in claim 15 including a pinion spring extending between said housing and said pinion gear to bias said pinion gear toward said driven gear to allow said second set of clutch teeth to engage said first set of clutch teeth.

17. A mechanical clutch assembly as set in claim 16 including a fastener fixedly securing said lever to said second shaft member.
